(19) United States
(12) Patent Application Publication
(10) Pub. No.: US 2002/0005269 A1
(43) Pub. Date: Jan. 17, 2002

(54) Engine coolant cooler

(76) Inventor: David William Meek, Silverstone (GB)

Correspondence Address: YOUNG & BASILE, P.C., Suite 624, 3001 West Big Beaver Road, Troy, MI, 48084, US

(21) Appl. No.: 09/882,236

(22) Filed: Jun. 15, 2001

(30) Foreign Application Priority Data
Jun. 17, 2000 (GB) 00 14747.0

(51) Int. Cl. B60H 3/00; B61D 27/00

(52) U.S. Cl. 165/42

(57) ABSTRACT

A marine jet drive has at least one stator comprising at least one hollow vane containing coolant passages. Coolant passes from the engine to cooler intake into manifold, through passages and axial manifold, and back to the engine through manifold and exit. The stator may be made of aluminum; the coolant may be water, or a water/glycol mixture. This design offers a large surface area for effective cooling, and protection against coolant contamination, and against cooling passage blockage by marine debris. Integration of the cooler into the jet drive saves weight and spaced compared to use of a separate cooler. Water passing through the jet drive is at ambient temperature, in turbulent flow and passes at high speed, further improving cooling efficiency.

### FIELD OF THE INVENTION

The present invention relates to an improved engine coolant cooler, for cooling a marine engine, which marine engine is used to drive a water jet.

### SUMMARY OF THE INVENTION

It is an object of the present invention to provide a marine engine coolant cooler in which the above disadvantages are reduced or substantially obviated. It is a further object of the present invention to provide an improved method of cooling marine engine cooling coolant.

In accordance with a first aspect of the invention, there is provided a heat exchanger for cooling the coolant of a marine engine used to drive a water jet, characterized in that the heat exchanger comprises a stator of the water jet, the stator having at least one stator vane, which stator vane is hollow and has an inlet for hot coolant from the marine engine and an outlet for cooled coolant.

In a preferred embodiment of the heat exchanger, the stator comprises a plurality of substantially circumferentially equi-spaced stator vanes projecting generally radially outwardly from a central region, each of the vanes comprising a duct extending from a radially outer end of the vane to a radially inner end of the vane through which the engine coolant can flow. Preferably the heat exchanger further comprises an inlet manifold for receiving hot coolant from the engine and an outlet manifold for receiving cooled coolant from the stator. The arrangement may be such that the inlet manifold is in fluid connection with the radially outer end of the ducts of some of the vanes, and the outlet manifold is in fluid connection with the radially outer end of the ducts of the remainder of the vanes, the radially inner ends of the ducts of all the vanes being fluidly interconnected such that engine coolant can flow from the inlet manifold to the outlet manifold through the vanes.

It is also preferred that the or each stator vane is made of aluminum. In a particularly preferred embodiment the stator is cast.

The marine engine coolant may be any suitable fluid, for example water or a water/glycol mixture.

In accordance with a second aspect of the invention, there is provided a method of cooling the coolant of a marine engine used to drive a water jet, the water jet having a stator and the method comprising passing the engine coolant through a stator vane of the stator.

The invention further provides a stator adapted for use in the heat exchanger according to the first aspect of the invention or for use in the method of cooling the coolant of a marine engine according to the second aspect of the invention.

A marine engine coolant cooler in accordance with the invention has a large surface area for effective cooling and is less susceptible to cooling passage blockage by marine debris than known coolers. It is also an advantage that the position of the stator in the water jet ensures a supply of high velocity, high turbulence raw water flow over the vane(s) providing for extremely efficient heat transfer in the heat exchanger. Furthermore, integration of the cooler into the jet drive saves weight and space compared to the use of a separate cooler.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

An embodiment of a marine engine coolant cooler will now be described, by way of example only, with reference to the accompanying drawings, in which:

FIG. 1 is a schematic drawing of an embodiment of a marine engine coolant cooler shown in a cooling system with a marine engine; and

FIG. 2 is a section on the line A-A of FIG. 1, showing the stator in detail.

### DESCRIPTION OF THE PREFERRED EMBODIMENT

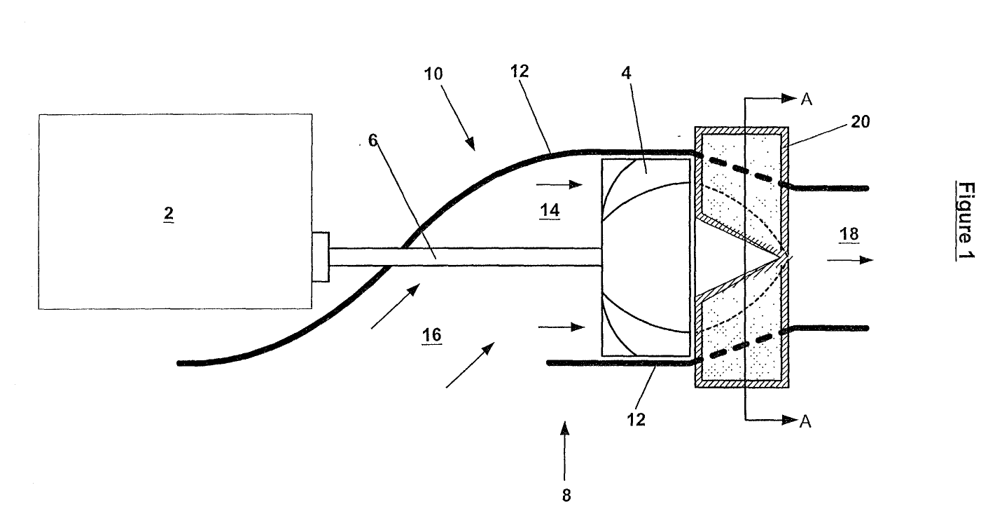

As can be seen from FIG. 1, a marine drive system shown generally at 10 comprises a marine engine 2, an impeller 4 and a drive shaft 6, one end of which is attached to the output of the marine engine 2 and the other end of which is drivingly attached to the impeller 4. A jet pump shown generally at 8 comprises a housing 12 surrounding a duct 14 in which the impeller 4 is located. The duct 14 comprises a duct inlet 16 located upstream of the impeller 4 and a duct outlet 18 located downstream of the impeller 4. The direction of water flow in the duct 14 is shown by arrows.

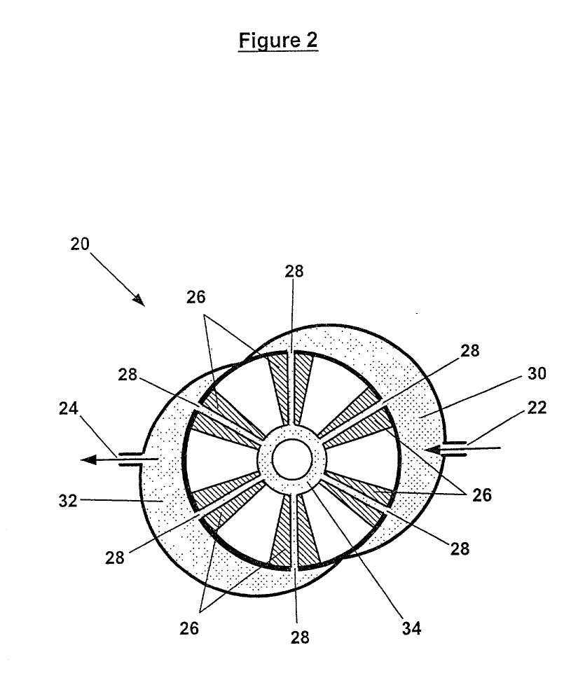

A stator 20, made of aluminum or aluminum alloy, is fixedly mounted in the duct 14 between the impeller 4 and the duct outlet 18 and comprises a set of hollow vanes 26. Preferably, the stator is cast but it can also be made from sheet material. The construction of the stator 20 is shown in more detail in FIG. 2. The hollow portions of the vanes 26 form a series of ducts 28. The ducts 28 in the vanes 26 radiating from one side of the stator 20 are connected to a first manifold 30 with an inlet 22 for receiving an incoming flow of hot engine coolant coming from the engine 2. All of the ducts 28 are connected about a central manifold 34 positioned axially in the duct 14. The ducts 28 in the vanes 26 radiating from the other side of the stator 20 are connected to a second manifold 32 with an outlet 24, for returning an outgoing flow of cooled engine coolant to the engine. The engine coolant is preferably either water or a mixture of water and glycol, but may be of any suitable liquid.

In operation, the marine engine 2 drives the drive shaft 6 either directly or via a gear box (not shown). As the drive shaft 6 rotates, it drives the impeller 4 which generates a flow of water along the duct 14, through the stator 20 and out through the outlet 18. The vessel in which the drive system 10 is installed is thus propelled through the water. Therefore whenever the vessel is moving through water, cold water from the river, lake or other expanse of water in which the vessel is floating, passes over the stator 20. In some water jets, there may be more than one stator 20.

Engine coolant is pumped from an outlet of the engine 2 through the inlet 22 of the first manifold 30, into the series of ducts 28 linked by the central manifold 34, into the second manifold 32, and then out through the outlet 24 and back to an inlet of the engine. A closed circulating path between the engine 2 and the stator 20 thus operates as a heat exchanger, allowing hot engine coolant entering the stator 20 at the coolant inlet 22 to be cooled by the water in the duct 14 before it leaves the stator 20 at the coolant outlet 24.

The high flow rate of raw water in the duct 14 means that the temperature of the raw cooling water in contact with the cooling vanes 26 of the stator 20 is substantially always at the ambient temperature of the raw water. Therefore the temperature differential between the engine coolant and the raw cooling water is maximized for maximum heat transfer. Furthermore, the number of vanes in the stator provides a large surface area for effective heat transfer.

Due to the closed circulating path between the engine 2 and the stator 20, the engine coolant is not easily contaminated, and the high flow rate of raw water in the duct 14 helps to prevent blockages from water borne debris.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A heat exchanger for cooling the coolant of a marine engine used to drive a water jet, characterized in that the heat exchanger comprises a stator of the water jet, the stator having at least one stator vane, which stator vane is hollow and has an inlet for hot coolant from the marine engine and an outlet for cooled coolant.

2. A heat exchanger according to claim 1 in which the stator comprises a plurality of substantially circumferentially equi-spaced stator vanes projecting generally radially outwardly from a central region, each of the vanes comprising a duct extending from a radially outer end of the vane to a radially inner end of the vane through which the engine coolant can flow.

3. A heat exchanger according to claim 2, further comprising an inlet manifold for receiving hot coolant from the engine and an outlet manifold for receiving cooled coolant from the stator.

4. A heat exchanger according to claim 3 in which the inlet manifold is in fluid connection with the radially outer end of the ducts of some of the vanes, and the outlet manifold is in fluid connection with the radially outer end of the ducts of the remainder of the vanes, the radially inner ends of the ducts of all the vanes being fluidly interconnected such that engine coolant can flow from the inlet manifold to the outlet manifold through the vanes.

5. A heat exchanger according to claim 1 in which the or each stator vane is made of aluminium or an aluminium alloy.

6. A heat exchanger according to claim 5 in which the stator is cast.

7. A method of cooling the coolant of a marine engine used to drive a water jet, the water jet having a stator and the method comprising passing the engine coolant through a stator vane of the stator.

8. A method as claimed in claim 7 in which the coolant is water.

9. A method as claimed in claim 7 in which the marine engine coolant is a water/glycol mixture.

10. A stator adapted for use in the heat exchanger according to claim 1 or for use in the method of cooling the coolant of a marine engine according to claim 7.
